(19) United States
(12) Patent Application Publication
(10) Pub. No.: US 2026/0143381 A1
(43) Pub. Date: May 21, 2026

(54) DUAL CONNECTIVITY UPLINK DATA SPLITTING BASED ON FEEDBACK FROM LOWER LEVEL LAYERS

(71) Applicant: GOOGLE LLC, Mountain View, CA (US)

(72) Inventors: Ignacio Agustín Guarna, Palo Alto, CA (US); Adedayo Olumayowa Aderibole, Boston, MA (US); Alexei Yurievitch Gorokhov, San Diego, CA (US)

(21) Appl. No.: 19/330,355

(22) Filed: Sep. 16, 2025

Related U.S. Application Data
(60) Provisional application No. 63/721,703, filed on Nov. 18, 2024.

(51) Int. Cl. H04W 28/08; H04L 69/322

(52) U.S. Cl. CPC H04W 28/0858; H04L 69/322

(57) ABSTRACT

User equipment includes a transceiver configured to transmit and receive signals over an air interface, a memory configured to store executable instructions, a processor configured to execute instructions stored in the memory. The processor executes the instructions to measure characteristics of uplink channels of the air interface at a first physical (PHY) layer and a second PHY layer. The processor also executes instructions to selectively route data from a packet data convergence protocol (PDCP) layer to one or more of a first radio link control (RLC) layer associated with the first PHY layer and a second RLC layer associated with the second PHY layer based upon the characteristics of the uplink channels.

### BACKGROUND

The Third Generation Partnership Project (3GPP) defines standards and protocols that govern, among other things, the handover of user equipment between different cells that provide wireless connectivity to the user equipment over an air interface. Examples of the standards defined by the 3GPP include the Fourth Generation Long Term Evolution (4G LTE) and Fifth Generation New Radio (5G NR) standards. User equipment that operates according to these standards can maintain connections with a serving cell in a connected mode or an idle mode. Some user equipment include an uplink stack that supports dual concurrent connections. For example, user equipment can include one portion of the stack that operates according to 4G LTE and a second portion that operates according to 5G NR standards. This configuration is referred to as E-UTRAN New Radio-Dual Connectivity (ENDC). For another example, user equipment can include separate portions of the stack that both operate according to 5G NR standards. This configuration is referred to as New Radio-Dual Connectivity (NRDC).

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a communication system that supports dual connectivity uplink data splitting based on feedback received at upper layers of the uplink data stack from lower layers of the uplink data stack, according to some embodiments.

FIG. 2 illustrates user equipment that supports dual connectivity and uplink data splitting, according to some embodiments.

FIG. 3 illustrates a method of uplink data splitting by user equipment that is configured for dual connectivity, according to some embodiments.

### DETAILED DESCRIPTION

The uplink stack in user equipment that supports dual connectivity includes a single (higher-level) packet data convergence protocol (PDCP) layer that provides packets or protocol data units (PDUs) to lower-level layers in separate uplink stacks. In some cases, each of the uplink stacks includes a radio link control (RLC) layer that receives data from the PDCP, a media access control (MAC) layer that receives data from the RLC layer, and a physical layer (PHY) that receives data from the RLC layer and transmits the data over the air interface using one or more antennas. In some cases, the PDCP, RLC, and MAC layers are collectively referred to as Layer 2 (L 2 ) and the PHY layer is referred to as Layer 1 (L 1 ). Thus, dual connectivity user equipment includes two RLC layers, two MAC layers, and two PHY layers.

The two PHY layers are configured to transmit over different wireless uplink channels. For example, in a user equipment configured to operate in ENDC, the master cell group (MCG) PHY layer and the secondary cell group (SCG) PHY layer transmit over wireless uplink channels allocated to 4G LTE and 5G NR, respectively. For another example, in a user equipment configured to operate in NRDC, the MCG PHY layer and the SCG PHY layer transmit over low-frequency and high-frequency wireless uplink channels, respectively. User equipment are required to split uplink data packets between the MCG and SCG according to configuration information transmitted to the user equipment by the network. For example, configuration information for the “moreThanOneRLC” mode dictates that the PDCP layer is required to split data between the two RLC entities when there is more than one RLC entity available. The configuration information can be communicated to the user equipment through a radio resource control (RRC) layer.

The distribution of data between the two RLC entities can have a significant impact on the power consumption of the user equipment. As discussed herein, the PHY layers associated with the two RLC entities transmit over different wireless channels. Differences in channel characteristics such as path loss, interference, and other channel impairments can lead to significant differences in the efficiencies (e.g., in terms of bits/joule) of transmission by the different PHY layers. The network is unaware of channel conditions, and therefore the configuration dictated by the network can be detrimental to performance and power consumption by the user equipment. Following the network configuration can cause the user equipment to deliver poor user experience that also reduces the spectral efficiency observed by the network. Furthermore, in conventional user equipment, the PDCP is unaware of measurements of channel conditions performed at the PHY layer and therefore cannot redistribute data between the two available layer stacks to avoid poor channel conditions and preferentially route data over the channel with the best channel conditions.

Routing of data that leads to a poor user experience and/or low spectral efficiency occurs in ENDC band combinations that operate the LTE PHY in a low band concurrently with operating the NR PHY in a high band, e.g., the band combination 13A_n77A. The path loss in band 13 can be significantly lower than in n77 and its block error rate (BLER) can also be significantly lower. However, the user equipment must follow the “moreThanOneRLC” configuration provided by the network and utilize both bands in roughly equal proportion. Consequently, the user equipment routes a portion of the data for transmission over the uplink using the less efficient band n77.

The spectral efficiency of uplink transmissions from user equipment is improved, and the power consumption of the user equipment is reduced, by selectively routing data from a PDCP layer to one or more of a first RLC layer and a second RLC layer in the user equipment based upon information indicating channel characteristics. Feedback representing the channel characteristics is received from a first PHY layer and a second PHY layer associated with the first and second RLC layers, respectively. In some embodiments, the information indicating the channel characteristics includes one or more metrics such as an uplink channel frequency, an uplink path loss, an uplink BLER, a transmit power, an average uplink modulation and coding scheme (MCS), an average uplink resource block (RB) size, and the like.

The PDCP layer can selectively route the data to the first or second RLC layer based on differences in the estimated uplink transmission efficiencies reported by the first and second PHY layers, differences in an estimated throughput capacity or latency in the uplinks reported by the first and second PHY layers, or differences in combinations of these metrics or other computed metrics. The PDCP layer can also selectively route the data to the first and/or second RLC layer based upon configuration information received from the network. In some embodiments, the PDCP layer ignores the configuration information received from the network in response to signaling from an external module such as a request for “efficient UL data split” mode. The PDCP layer can decide to exit the “efficient UL data split” mode at any time. For example, the PDCP layer can decide to exit the “efficient UL data split” mode for latency sensitive data, where the 5G RLC should be prioritized. For another example, the PDCP layer can decide to exit this mode to adopt a conservative approach that routes data through 5G when peak performance is required.

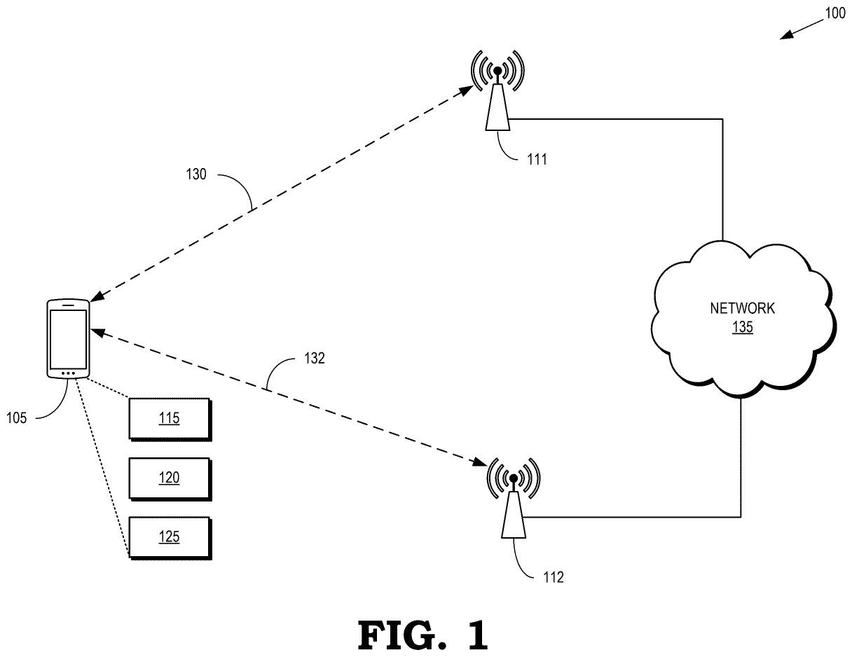

FIG. 1 illustrates a communication system 100 that supports dual connectivity uplink data splitting based on feedback received at upper layers of the uplink data stack from lower layers of the uplink data stack, according to some embodiments. The communication system 100 includes one or more user equipment 105 that can establish wireless connections over an air interface with one or more base stations or cells 111, 112. The user equipment 105 and the cells 111, 112 operate according to standards and protocols such as the standards defined by the 3GPP. For example, the user equipment 105 and the cells 111, 112 can operate according to the Fourth Generation Long Term Evolution (4G LTE) standard, the Fifth Generation New Radio (5G NR) standard, or a combination thereof. The user equipment 105 includes a transceiver 115 configured to transmit and receive signals over an air interface, a memory 120 configured to store executable instructions, and a processor 125 configured to execute instructions stored on the memory 120.

The user equipment 105 implements an uplink data stack that includes a single PDCP layer and dual data stacks including RLC layers, MAC layers, and PHY layers, as discussed herein. The dual data stacks are configured to support concurrent connections with multiple cells, such as the cells 111, 112. In some embodiments, the cells 111, 112 are referred to as a master cell 111 and a secondary cell 112, which can be members of a master cell group (MCG) and a secondary cell group (SCG), respectively. For example, in NRDC, the user equipment 105 establishes a first connection 130 with the master cell 111, which is typically a 5G NR base station. The user equipment 105 can establish a concurrent connection 132 to one or more secondary cells, such as the secondary cell 112. The secondary cells can be implemented as LTE base stations. The master cell 111 is responsible for managing the overall connection, which includes the connections 130, 132. The secondary cell 112 (and any other available secondary cells) provide additional coverage and capacity.

Network 135 manages dual connectivity by coordinating the scheduling and resource allocation between the master cell 111 and the secondary cell 112, as well as any other available secondary cells. As discussed herein, the network 135 can provide configuration information to the user equipment 105 via the master cell 111 or the secondary cell 112. For example, the configuration information can instruct the user equipment 105 to route a first percentage or fraction of data over the connection 130 to the master cell 111 and a second percentage or fraction of data over the connection 132 to the secondary cell 112. As discussed herein, the distribution of data between the two RLC entities can have a significant impact on the power consumption of the user equipment but network 135 is typically unaware of the uplink channel conditions. The configuration dictated by the network 135 can therefore be detrimental to performance and power consumption by the user equipment 105, as well as reducing the spectral efficiency observed by the network 135.

The user equipment 105 is configured to measure characteristics of uplink channels 130, 132 of the air interface. In some embodiments, the measurements are performed at a first PHY layer and a second PHY layer implemented in the user equipment 105. The user equipment 105 also includes a PDCP layer that is configured to selectively route data to one or more of a first RLC layer associated with the first PHY layer and a second RLC layer associated with the second PHY layer based upon the characteristics of the uplink channels 130, 132. The first PHY layer and the second PHY layer in the user equipment 105 are configured to provide information representing the characteristics of the uplink channels 130, 132 to the PDCP layer.

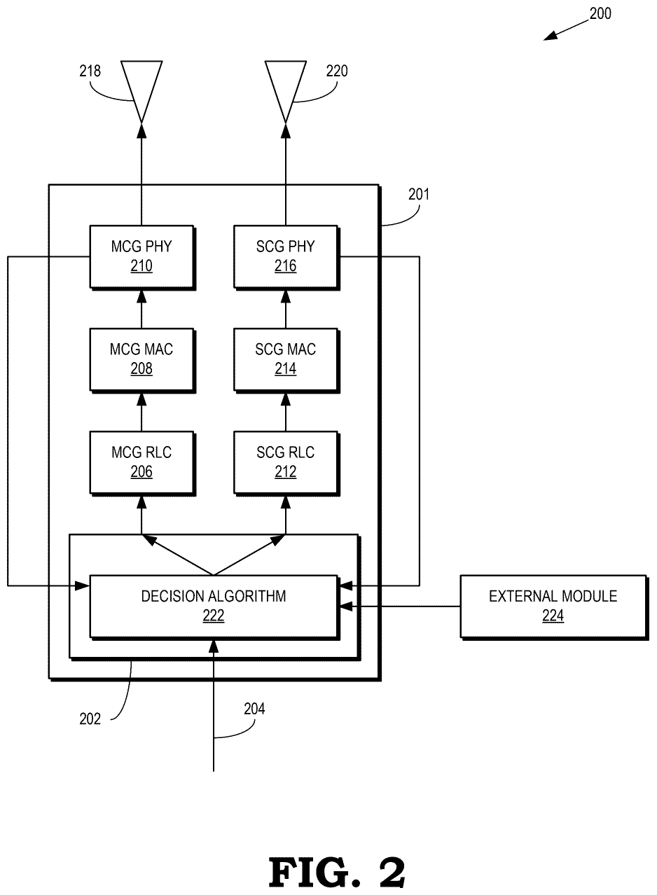

FIG. 2 illustrates user equipment 200 that supports dual connectivity and uplink data splitting, according to some embodiments. The user equipment 200 is used to implement some embodiments of user equipment 105 shown in FIG. 1. In the illustrated embodiment, the user equipment 200 includes a transceiver 201. A PDCP layer 202 is implemented in the transceiver 201 using circuitry configured to receive incoming data 204 that is to be transmitted over one or uplink channels to a network such as the network 135 shown in FIG. 1. In the illustrated embodiment, the PDCP layer 202 provides services to upper layers implemented in user equipment 200. For example, the PDCP layer 202 can provide services including, but not limited to, transfer of user plane data, transfer of control plane data, header compression, ciphering, and integrity protection.

Dual connectivity is supported by including two layer stacks that receive data from the PDCP layer 202. A first layer stack supports communication to an MCG and includes an MCG RLC 206, an MCG media access control (MAC) layer 208, and an MCG PHY layer 210. A second layer stack supports communication to an SCG and includes an SCG RLC 212, an SCG MAC layer 214, and an SCG PHY layer 216. The RLC layers 206, 212 are responsible for transfer of upper layer packet data units (PDUs), concatenation, segmentation and reassembly of RLC service data units (SDUs), as well as performing error correction. The MAC layers 208, 214 are responsible for controlling the hardware responsible for interaction with the wired (electrical or optical) or wireless transmission medium. The PHY layers 210, 216 provide an electrical, mechanical, and procedural interface to the transmission medium, e.g., via the antennae 218, 220. The shapes and properties of the electrical connectors, the frequencies to transmit on, the line code to use and similar low-level parameters, are specified by the PHY layers 210, 216.

The PDCP layer 202 includes circuitry configured to implement a decision algorithm 222 that determines how to selectively route data the PDCP layer 202 to one or more of the RLC layers 206, 212. The decision algorithm 222 performs the selective routing based upon characteristics of the uplink channels that are provided in feedback from the PHY layers 210, 216. In some embodiments, circuitry in the PHY layers 210, 216 is configured to measure or otherwise determine one or more metrics are characteristics associated with the uplink channels used by the corresponding first and second layer stacks. Examples of the metrics that are measured or determined by the PHY layers 210, 216 include, but are not limited to, frequencies of the uplink channels, path losses of the uplink channels, BLERs for packets transmitted over the uplink channels, transmit powers of the uplink channels, average uplink MCSs of the uplink channels, or average RB sizes of the uplink channels.

Based on the feedback received from the PHY layers 210, 216, the decision algorithm 222 determines whether to route data to the MCG RLC 206, the SCG RLC 212, or a combination thereof. The decision algorithm 222 can decide how to route the data based on the metrics received from the PHY layers 210, 216 or other parameters that are determined based on these metrics. For example, the decision algorithm 222 can determine how to selectively route the data based on differences in estimated transmission efficiencies of the uplink channels reported by the PHY layers 210, 216. For another example, the decision algorithm 222 can determine how to selectively route the data based on differences in an estimated throughput capacity or latency of the uplink channels reported by the PHY layers 210, 216. For yet another example, the decision algorithm 222 can determine how to selectively route the data based on a combination of differences in estimated transmission efficiencies, estimated throughput capacity, or estimated latency of the uplink channels. Some embodiments of the decision algorithm 222 implement a model of the radiofrequency front-end module utilized by the PHY layers 210, 216 and use this model to estimate the uplink transmission efficiency. The decision algorithm 222 can use the model to calculate the front end power consumption based on the frequency band and the transmission power, e.g., using an exponential curve fit with different constant values for each frequency band. Based on this calculated power, the model obtains the average energy per bit of each RLC 206, 212. Other embodiments of the model account for modulation and coding schemes or other L1 parameters.

Some embodiments of the decision algorithm 222 selectively route the data based on information received from external sources. For example, the decision algorithm 222 can selectively route data based upon configuration information received from a network such as the network 135 shown in FIG. 1. The configuration information can include information such as a percentage of data that should be transmitted over each of the two layer stacks. In some embodiments, the decision algorithm 222 can ignore the configuration information received from the network in response to signaling from an external module 224. For example, the external module 224 can send a signal, such as a request for “efficient UL data split” mode, instructing the decision algorithm 222 to ignore the constraints imposed by the configuration information sent by the network.

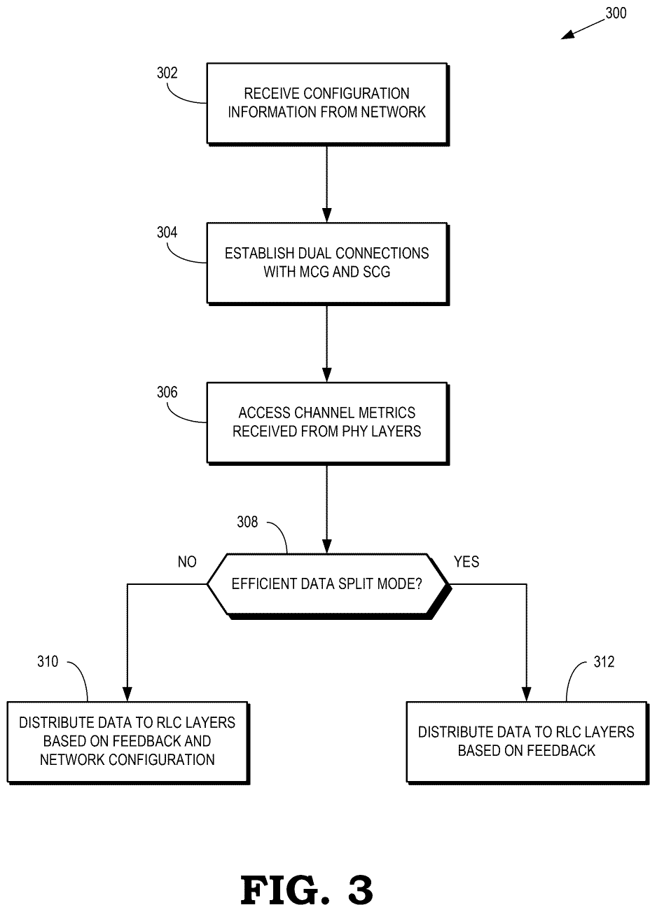

FIG. 3 illustrates a method 300 of uplink data splitting by user equipment that are configured for dual connectivity, according to some embodiments. The method 300 is implemented in some embodiments of user equipment 105 shown in FIG. 1 and user equipment 200 shown in FIG. 2.

At block 302, the user equipment receives configuration information from a network such as the network 135 shown in FIG. 1. As discussed herein, the user equipment can use the configuration information to determine how to route data along the available layer stacks and connections.

At block 304, the user equipment establishes dual connections with first and second cells or cell groups. In the illustrated embodiment, concurrent connections are formed with an MCG and an SCG, as discussed herein. The user equipment can begin transmitting or receiving signals over the connections. In some embodiments, the transmitted or received signals are used to measure or determine characteristics of the uplink channels on the concurrent connections. Lower layers, such as the PHY layers, in the user equipment provide feedback indicating values of the characteristics, or other metrics, to higher layers such as a PDCP layer.

At block 306, the PDCP layer accesses values of the channel characteristics or metrics received from the PHY layers.

At decision block 308, the PDCP layer determines whether an external module has provided a signal indicating that the PDCP layer should operate in an efficient data split mode. If the PDCP layer has not received signaling from the external module, the method 300 flows to block 310. If the PDCP layer received signaling from the external module indicating the efficient data split mode, the method 300 flows the block 312.

At block 310, the PDCP layer selectively routes data based, at least in part, on constraints indicated by the configuration information received from the network. Thus, the PDCP layer selectively routes the data based on the feedback received from the PHY layers and the network configuration information.

At block 312, the PDCP layer does not consider the network configuration information and selectively routes the data based on the feedback received from the PHY layers.

Note that not all the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the embodiments disclosed above may be altered or modified and all such variations are considered within the scope of the disclosed subject matter. Accordingly, the protection sought herein is set forth in the claims below.

What is claimed is:

1. User equipment comprising:
a transceiver configured to transmit and receive signals over an air interface;
a memory configured to store executable instructions;
a processor configured to execute instructions stored in the memory, the instructions to manipulate the processor to:
measure, at a first physical (PHY) layer and a second PHY layer, characteristics of uplink channels of the air interface; and
selectively route data from a packet data convergence protocol (PDCP) layer to one or more of a first radio link control (RLC) layer associated with the first PHY layer and a second RLC layer associated with the second PHY layer based upon the characteristics of the uplink channels.

2. The user equipment of claim 1, further comprising:
providing information representing the characteristics of the uplink channels of the air interface from the first PHY layer and the second PHY layer to the PDCP layer.

3. The user equipment of claim 1, wherein the characteristics of the corresponding channels comprise at least one of a frequency of at least one of the uplink channels, a path loss of at least one of the uplink channels, a block error rate (BLER) of at least one of the uplink channels, a transmit power of at least one of the uplink channels, an average uplink modulation and coding scheme (MCS) of at least one of the uplink channels, or an average resource block (RB) size of at least one of the uplink channels.

4. The user equipment of claim 1, wherein the PDCP layer is configured to selectively route the data to the first RLC layer or second RLC layer based on differences in estimated transmission efficiencies of the uplink channels reported by the first and second PHY layers.

5. The user equipment of claim 1, wherein the PDCP layer is configured to selectively route the data to the first RLC layer or the second RLC layer based on differences in an estimated throughput capacity or latency of the uplink channels reported by the first and second PHY layers.

6. The user equipment of claim 1, wherein the PDCP layer is configured to selectively route the data to the first RLC layer or the second RLC layer based on a combination of differences in estimated transmission efficiencies, estimated throughput capacity, or estimated latency of the uplink channels.

7. The user equipment of claim 1, wherein the PDCP layer is configured to selectively route the data to the first RLC layer or the second RLC layer based upon configuration information received from a network.

8. The user equipment of claim 7, wherein the PDCP layer is configured to ignore the configuration information received from the network in response to signaling from an external module.

9. A method of operating the user equipment of claim 1, the method including:
measuring, at the first physical (PHY) layer and the second PHY layer, characteristics of uplink channels of the air interface; and
selectively routing data from the packet data convergence protocol (PDCP) layer to one or more of the first radio link control (RLC) layer associated with the first PHY layer and the second RLC layer associated with the second PHY layer based upon the characteristics of the uplink channels.

10. The method of claim 9, further comprising:
providing information representing the characteristics of the uplink channels of the air interface from the first PHY layer and the second PHY layer to the PDCP layer.
